(19) United States
(12) Patent Application Publication
(10) Pub. No.: US 2020/0296206 A1
(43) Pub. Date: Sep. 17, 2020

(54) APPARATUS AND METHOD FOR EXECUTING MENU IN PORTABLE TERMINAL

(71) Applicant: Samsung Electronics Co., Ltd., Gyeonggi-do (KR)

(72) Inventor: Hyun-Tae JUNG, Seoul (KR)

(21) Appl. No.: 16/885,592

(22) Filed: May 28, 2020

Related U.S. Application Data
(63) Continuation of application No. 13/316,789, filed on Dec. 12, 2011.

(30) Foreign Application Priority Data
Dec. 13, 2010 (KR) 10-2010-0127063

(51) Int. Cl. H04M 1/725; H04M 1/60

(52) U.S. Cl. CPC H04M 1/72583; H04M 1/6058

(57) ABSTRACT

Provided is an apparatus and method for executing a menu in a portable terminal, which makes it possible to conveniently execute an earphone-aided menu in a portable terminal. An apparatus for executing a menu in a portable terminal includes an earphone connection detecting unit and a control unit. The earphone connection detecting unit is configured to detect the connection of an earphone to the portable terminal. The control unit is configured to display earphone-aided menus in a pop-up window when the earphone is connected to the portable terminal.

### CLAIM OF PRIORITY

This application is a Continuation of U.S. patent application Ser. No. 13/316,789 filed on Dec. 12, 2011 which claims the benefit under 35 U.S.C. § 119 of a Korean Patent Application filed in the Korean Intellectual Property Office on Dec. 13, 2010 and assigned Serial No. 10-2010-0127063, the entire disclosure of which is hereby incorporated by reference.

### BACKGROUND OF THE INVENTION

### Field of the Invention

The present invention relates generally to an apparatus and method for executing a menu in a portable terminal, and more particularly, to an apparatus and method for conveniently executing an earphone-aided menu in a portable terminal.

### Description of the Related Art

Recently, portable terminals are providing an ever increasing number of additional functions, which include a Ffile playing function for playing prestored audio/video files such as music files and English learning files, a camera function for taking still or moving pictures, a digital broadcast playing function for playing broadcast data received from a broadcasting station, a wireless Internet function for providing a 25 wireless Internet service, and a message function for transmitting/receiving text or multimedia messages.

The audio file playing function plays various audio files stored in the portable terminal via a speaker of the portable terminal. To this end, a user often uses an earphone 30 for privacy and to hear the audio signals more clearly. The earphone is further used during an FM radio listening function, a DMB listening function, and a call function.

However, there is a drawback in using the earphone as the user is inconvenienced by having to search the top menu of the portable terminal for a desired function in a top-down manner after connecting the earphone to the portable terminal.

### SUMMARY OF THE INVENTION

An exemplary embodiment of the present invention is to provide an apparatus and method for executing a menu in a portable terminal, which makes it possible to conveniently execute an earphone-aided menu in a portable terminal.

According to an aspect of the present invention, an apparatus for executing a menu in a portable terminal includes: an earphone connection detecting unit configured to detect the connection of an earphone to the portable terminal; and a control unit configured to display earphone-aided menus when the earphone is connected to the portable terminal.

According to another aspect of the present invention, a method for executing a menu in a portable terminal includes: determining whether an earphone is connected to the portable terminal; and displaying earphone-aided menus when the earphone is connected to the portable terminal.

According to yet another aspect of the invention, a mobile terminal for executing a menu includes: a display unit; an earphone connection detecting unit configured to detect the connection of an earphone to the portable terminal; and a control unit configured to display earphone-aided menus in a pop-up window of the display unit when the earphone is coupled to the portable terminal.

### BRIEF DESCRIPTION OF THE DRAWINGS

The above and other aspects, features and advantages of certain exemplary embodiments of the present invention will be more apparent from the following description taken in conjunction with the accompanying drawings, in which: FIG. 1 is a block diagram of a portable terminal according to an exemplary embodiment of the present invention; and

FIG. 2 is a flow diagram illustrating a process for executing an earphone-aided menu in a portable terminal according to an exemplary embodiment of the present invention.

### DETAILED DESCRIPTION OF THE INVENTION

Exemplary embodiments of the present invention will be described below in detail with reference to the accompanying drawings. Like reference numerals in the drawings denote like elements. The present invention may, however, be embodied in different forms and should not be construed as limited to the embodiments set forth herein; rather, these embodiments are provided so that this disclosure will be thorough and complete, and will fully convey the scope of the present invention to those skilled in the art.

FIG. 1 is a block diagram of a portable terminal according to an exemplary embodiment of the present invention.

Referring to FIG. 1, a portable terminal according to an exemplary embodiment of the present invention includes a control unit 110, a data processing unit 120, a radio frequency (RF) unit 123, an audio processing unit 125, a key input unit 127, a memory unit 130, a camera unit 140, a video processing unit 150, a display unit 160, and an earphone connection detecting unit 170.

The RF unit 123 performs a wireless communication function of the portable terminal. The RF unit 123 includes an RF transmitter for upconverting and amplifying a TX signal, and an RF receiver for low-noise-amplifying and downconverting an RX signal. The data processing unit 120 includes a transmitter for encoding and modulating the TX signal, and a receiver for demodulating and decoding the RX signal. For example, the data processing unit 120 includes a modem and a codec. Herein, the codec includes a data codec for processing packet data, and an audio codec for processing audio signals (e.g., voice signals). The audio processing unit 125 processes an RX audio signal outputted from the audio codec of the data processing unit 120, and transmits a TX audio signal, generated by a microphone, to the audio codec of the data processing unit 120.

The key input unit 127 includes keys for inputting numeral and character information, and function keys for setting various functions.

The memory unit 130 may include a program memory and a data memory. The program memory may store programs for controlling general functions of the portable terminal, and programs for performing a control operation to display only the earphone-aided menus when an earphone is connected to the portable terminal.

The control unit 110 controls an overall operation of the portable terminal.

According to an exemplary embodiment, when receiving an earphone connection detection signal from the earphone connection detecting unit 170 and determining that the earphone is connected to the portable terminal, the control unit 110 notifies the earphone connection and displays only the earphone-aided menus in a pop-up window. In alternate embodiment, the detection unit 170 and the controller unit 110 may be integrated as a single unit to perform both the detection and display of the earphone-aided menus in the pop-up window.

According to an exemplary embodiment, if the portable terminal is in an idle mode during the detection of the earphone connection, the control unit 110 displays the earphone-aided menus.

According to an exemplary embodiment, if the portable terminal is in an earphone-unaided mode during the detection of the earphone connection, the control unit 110 displays the earphone-aided menus.

According to an exemplary embodiment, if the portable terminal is in an earphone-aided mode during the detection of the earphone connection, the control unit 110 performs the earphone-aided mode through the earphone.

According to an exemplary embodiment, if a desired menu is selected from the earphone-aided menus, the control unit 110 performs the mode of the selected menu through the earphone.

Examples of the earphone-aided menus include a music playing menu, an FM radio menu, a DMB menu, and a call function menu, which can be executed through the earphone.

When the earphone is connected to the portable terminal, the earphone connection detecting unit 170 detects the earphone connection and transmits an earphone connection detection signal to the control unit 110.

Referring back to FIG. 1, the camera unit 140 includes a camera sensor for capturing video data and converting the video data into an electrical signal, and a signal processing unit for converting an analog video signal, captured by the camera sensor, into digital data. The camera sensor may include a CCD sensor or a CMOS sensor, and the signal processing unit may include a digital signal processor (DSP). Also, the camera sensor and the signal processing unit may be integrated into one unit, or may be separated from each other.

A video processing unit 150 performs an image signal processing (ISP) operation to display video signals, outputted from the camera unit 140, on the display unit 160. Examples of the ISP operation include gamma correction, interpolation, spatial change, image effects, image scaling, auto white balance (AWB), auto exposure (AE), and auto focus (AF). The video processing unit 150 processes the video signals, outputted from the camera unit 140, on a frame basis, and outputs the frame video data according to the size and characteristics of the display unit 160. Also, the video processing unit 150 includes a video codec to compress the frame video data displayed on the display unit 160 and restore the compressed frame video data into the original frame video data. The video codec may include a JPEG codec, an MPEG4 codec, or a Wavelet codec. The video processing unit 150 may have an on-screen display (OSD) function to output OSD data in accordance with a display screen size under the control of the control unit 110.

The display unit 160 displays the video signal outputted from the video processing unit 150, and displays the user data outputted from the control unit 110. The display unit 160 may be implemented using an LCD. If the display unit 160 is implemented using an LCD, the display unit 160 may include an LCD, an LCD controller, and a memory for storing video data. The LCD may be a touchscreen LCD. If the LCD is a touchscreen LCD, it may also operate as an input unit. Also, the display unit 160 may display the keys of the key input unit 127.

According to an exemplary embodiment, when the earphone is connected to the portable terminal, the display unit 160 displays the earphone-aided menus in a pop-up window so that the user can readily select a desired item without going through in cumbersome navigation of menus as in the prior art.

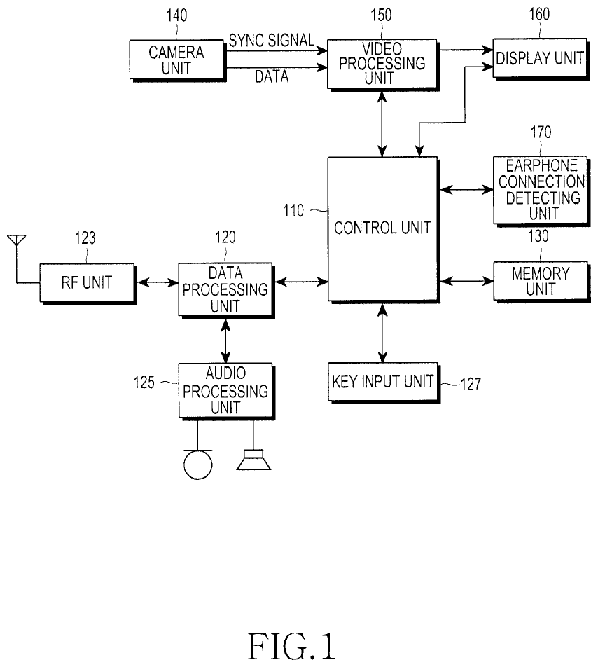

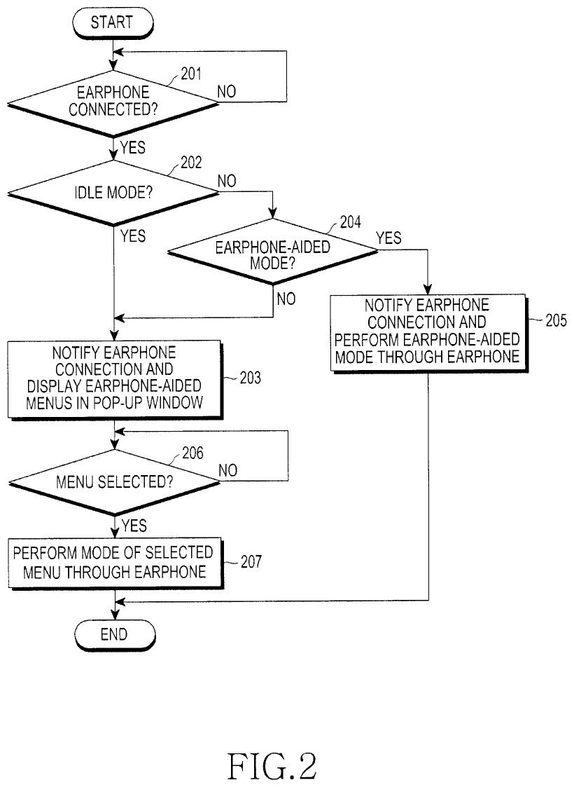

Hereinafter, a process for executing an earphone-aided menu in the portable terminal according to an exemplary embodiment of the present invention will be described below with reference to FIGS. 1 and 2.

FIG. 2 is a flow diagram illustrating a process for executing an earphone-aided menu in the portable terminal according to an exemplary embodiment of the present invention.

Referring to FIGS. 1 and 2, when the earphone is connected to the portable terminal, the earphone connection detecting unit 170 detects the earphone connection and transmits an earphone connection detection signal to the control unit 110. In step 201, the control unit 110 determines whether the earphone is connected to the portable terminal. If the earphone is connected to the portable terminal (in step 201), the control unit 110 proceeds to step 202. In step 202, the control unit 110 determines whether the portable terminal is in an idle mode.

If the portable terminal is in an idle mode (in step 202), the control unit proceeds to step 203. In step 203, the control unit 110 notifies the earphone connection and displays the earphone-aided menus on the display unit 160 in a pop-up window.

The earphone connection notification may be performed by at least one of notification sound, vibration and icon display.

Examples of the earphone-aided menus include a music playing menu, an FM radio menu, a DMB menu, and a call function menu, which can be executed through the earphone. The earphone-aided menus may be automatically generated or may be set by the user.

The earphone-aided menus described above may be displayed in the pop-up window in the order of use frequency.

If a desired menu of the user is not present among the earphone-aided menus displayed in step 203, the user may select a desired menu among the menus of the portable terminal and add the selected menu in the pop-up window in which the earphone-aided menus are displayed.

On the other hand, if the portable terminal is in a non-idle mode (in step 202), the control unit 110 proceeds to step 204. In step 204, the control unit 110 determines whether the non-idle mode is an earphone-aided mode.

If the non-idle mode is an earphone-unaided mode (in step 204), the control unit proceeds to step 203. In step 203, the control unit 110 notifies the earphone connection and displays the earphone-aided menus on the display unit 160 in a pop-up window.

If the non-idle mode is an earphone-aided mode (in step 204), the control unit proceeds to step 205. In step 205, the control unit 110 notifies the earphone connection and performs the earphone-aided mode through the earphone. Thereafter, the control unit 110 ends the process.

In step 206, the control unit 110 determines whether a desired menu is selected from the earphone-aided menus displayed in the pop-up window, the control unit 110 proceeds to step 207. In step 207, the control unit performs the mode of the selected menu through the earphone.

In the exemplary embodiment, if the earphone is still connected to the portable terminal after completion of the mode performed in step 205 or 207, the control unit 110 again displays the earphone-aided menus on the display unit 160 in a pop-up window.

In another exemplary embodiment, if the earphone is still connected to the portable terminal after completion of the mode performed in step 205 or 207, the control unit 110 displays an icon or a soft menu, which is used to select the earphone-aided menus, in a portion of the display region of the display unit 160 and displays the icon-aided menus on the display unit 160 when the icon or the soft menu is selected.

Accordingly, when the earphone is connected to the portable terminal, the 35 earphone-aided menus are displayed in a pop-up window. In another exemplary embodiment of the present invention, an icon or a soft menu for selecting the earphone-aided menus is displayed in a portion of the display region of the display unit 160, and the icon-aided menus are displayed by the user's selection.

As described above, the present invention provides an apparatus and method for executing a menu in a portable terminal by displaying only the earphone-aided menus in a pop-up window in the event of earphone connection, thereby making it possible to execute an earphone-aided menu rapidly and conveniently.

The above-described methods according to the present invention can be realized in hardware or as software or computer code that can be stored in a non-transitory recording medium such as a CD ROM, an RAM, a floppy disk, a hard disk, or a magneto-optical disk or downloaded over a network, so that the methods described herein can be rendered in such software using a general purpose computer, microprocessor or a special processor or in programmable or dedicated hardware, such as an ASIC or FPGA. As would be understood in the art, the computer, the processor, microprocessor (controller) or the programmable hardware include memory components, e.g., RAM, ROM, Flash, etc. that may store or receive software or computer code that when accessed and executed by the computer, processor or hardware implement the processing methods described herein.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method for a portable terminal, comprising:
displaying a user interface for setting an application which is automatically executed when an earphone is connected to the portable terminal on a display;
receiving a user input for setting an application from among a plurality of applications as the application which is automatically executed when the earphone is connected to the portable terminal, via the user interface;
detecting whether an earphone is connected to the portable terminal; and
in response to detecting connection of the earphone to the portable terminal, automatically executing the application set by the user input, and displaying on a screen of the display, a first execution screen of the application,
wherein the first execution screen of the application is the same as an execution screen displayed when an icon corresponding to the application is selected.

2. The method of claim 1, wherein the displaying the first execution screen further comprises:
displaying the first execution screen without displaying a plurality of icons corresponding to the plurality of applications or a menu comprising a plurality of items corresponding to the plurality of applications.

3. The method of claim 1, further comprising:
in response to detecting connection of the earphone to the portable terminal, providing a connection notification indicating the connection of the earphone to the portable terminal.

4. The method of claim 3, wherein the connection notification comprises at least one of a notification sound, a vibration, and an icon representing the connection of the earphone to the portable terminal

5. The method of claim 1, wherein the displaying the user interface further comprises:
displaying one or more application items which are currently installed on the portable terminal.

6. The method of claim 1, wherein automatically executing the application further comprises:
displaying a second screen instead of a first screen as the first execution screen of the application, the second screen including information relating to the executed application.

7. The method of claim 1, wherein the application comprises at least one of music playing application, a radio application, a broadcasting application, or a call application.

8. A portable terminal, comprising:
a display;
a memory configured to store a plurality of applications; and
at least one processor configured to:
control the display to display a user interface for setting an application which is automatically executed when an earphone is connected to the portable terminal,
receive a user input for setting an application from among the plurality of applications as the application which is automatically executed when the earphone is connected to the portable terminal, via the user interface, and
in response to detecting connection of an earphone to the portable terminal, automatically execute the application set by the user input, and control the display to display on a screen of the display, a first execution screen of the application,
wherein the first execution screen of the application is the same as an execution screen displayed when an icon corresponding to the application is selected.

9. The portable terminal of claim 8, the at least one processor further configured to:
control the display to display the first execution screen without displaying a plurality of icons corresponding to the plurality of applications or a menu comprising a plurality of items corresponding to the plurality of applications.

10. The portable terminal of claim 8, the at least one processor further configured to:
in response to detecting connection of the earphone to the portable terminal, provide a connection notification indicating the connection of the earphone to the portable terminal.

11. The portable terminal of claim 10, wherein the connection notification comprises at least one of a notification sound, a vibration, and an icon representing the connection of the earphone to the portable terminal

12. The portable terminal of claim 8, wherein the displaying the user interface further comprises:
displaying one or more application items which are currently installed on the portable terminal.

13. The portable terminal of claim 8, wherein automatically executing the application further comprises:
displaying a second screen instead of a first screen as the first execution screen of the application, the second screen including information relating to the executed application.

14. The portable terminal of claim 8, wherein the application comprises at least one of music playing application, a radio application, a broadcasting application, or a call application.
